(19) United States
(12) Patent Application Publication
(10) Pub. No.: US 2023/0035034 A1
(43) Pub. Date: Feb. 2, 2023

(54) AUTOMATIC ANIMAL DOOR SYSTEM

(71) Applicant: YONGJI CHEN, Shenzhen (CN)

(72) Inventor: YONGJI CHEN, Shenzhen (CN)

(21) Appl. No.: 17/390,940

(22) Filed: Jul. 31, 2021

(51) Int. Cl. E05F 15/79; E06B 7/32; E05F 15/60; E05F 15/77; E05F 15/76; H02J 7/35; H02P 25/06

(52) U.S. Cl. CPC E05F 15/79; E06B 7/32; E05F 15/60; E05F 15/77; E05F 15/76; H02J 7/35; H02P 25/06; E05F 2015/765

(57) ABSTRACT

The present invention provides an automatic animal door system. The automatic animal door system includes an animal door module, a linear motor driver and a control module. The animal door module includes a door and a frame having an opening, and the door is lively connected with the frame and configured to move between a closed position covering the opening and an open position away from the opening. The linear motor driver is connected with the door and configured to drive the door move between the closed position and the open position. The control module is electrically connected the linear motor driver and includes a processor and a non-volatile memory storing a programmed set of instructions. The processor executes the programmed set of instructions to control the linear motor driver open or close the door.

### FIELD OF THE INVENTION

The present invention generally relates to automatic door systems, and more particularly relates to an automatic door system for animals.

### BACKGROUND OF THE INVENTION

In recent years, the computerized management of access to and from buildings has become routine in industry and government. However, many of the systems utilized for such applications require that a user execute or pass a security step of one sort or another, such as card presentation to a card reader, password entry, or thumb print or retina scan, or the like. However, the requirements of many of such systems are not practically transferable for use with animals. Yet, with increasingly valuable contents in homes or other building structures, and with increasingly aggressive methods attempted by thieves to gain access to such valuable contents, it would be advantageous if a highly animal specific yet highly secure system were to become available for use, especially for home owners concerned about the potential security risks inherent in prior art animal entry systems. Consequently, there have been various attempts to develop security devices and methods for implementation of the same, for controlling passage of animals though doors into and out of secure areas such as homes, apartments, or other structures.

### SUMMARY OF THE INVENTION

The present invention provides an animal automatic door system including: an animal door module including a door and a frame having an opening, the door lively connected with the frame and configured to move between a closed position covering the opening and an open position away from the opening; an linear motor driver connected with the door and configured to drive the door move between the closed position and the open position; and a control module electrically connected the linear motor driver and including a processor and a non-volatile memory storing a programmed set of instructions, and the processor configured to execute the programmed set of instructions to control the linear motor driver open or close the door.

Further, the frame includes two sliding elements facing with each other, the two sliding elements are located at two sides of the opening, the door is connected with the two sliding elements in a sliding mode, and the control module is configured to control the linear motor driver drive the door slide along the two sliding elements so as to move between the closed position and the open position.

Further, each sliding element comprises a chute, two opposite sides of the door connected with the two chutes in a sliding mode and are configured to slide along the two chutes.

Further, the linear motor driver is fixed on a wall.

Further, the automatic animal door system further comprises a power source, the power source is electrically connected the control module and the linear motor driver respectively to supply the the control module and the linear motor driver.

Further, the power source is a wall outlet for receiving power from a utility line.

Further, the power source comprises at least one battery, or at least one rechargeable battery in conjunction with at least one solar cell that is adapted to recharge the at least one rechargeable battery.

Further, the control module further comprises a timing circuit for reporting date and time to the processor, the programmed set of instructions are adapted for receiving date and time signals from the timing circuit such that the processor executes the programmed set of instructions to control the door open or close via the linear motor driver.

Further, the processor executes the programmed set of instructions to open the door at sunrise time and close the door at sunset time based on the date and time signals from the timing circuit.

Further, the control module further comprises a wireless control circuit for reporting external wireless control signals to the processor, the programmed set of instructions are adapted for receiving the external wireless control signals from the wireless control circuit such that the processor executes the programmed set of instructions to control the door open or close via the linear motor driver.

Further, the external wireless control signals are Wi-Fi signals provided by an electrical device of a user such that the door is open or closed by the user via the electrical device.

Further, the control module further comprises a light sensor for detecting sunrise time and sunset time and reporting the sunrise time and the sunset time to the processor, such that the processor executes the programmed set of instructions to open the door at the sunrise time and close the door at the sunset time based upon the sunrise time and the sunset time.

Further, the control module further comprises an infrared sensor disposed on the frame and configured to detect whether an animal is located at the opening, when the infrared sensor detects an animal is located at the opening, the infrared sensor reports to the processor, and the processor executes the programmed set of instructions to open the door.

The present invention also provides an animal automatic door system including: an animal door module comprising two sliding elements facing with each other and a door, the door connected with the two sliding elements in a sliding mode, the door configured to slide along the two sliding elements between a closed position covering an opening between the two sliding elements and an open position away from the opening; an linear motor driver connected with the door and configured to drive the door slide between the closed position and the open position; and a control module electrically connected the linear motor driver, comprising a processor and a non-volatile memory storing a programmed set of instructions, and the processor configured to execute the programmed set of instructions to control the linear motor driver open or close the door.

Further, the control module further comprises a timing circuit for reporting date and time to the processor, the programmed set of instructions are adapted for receiving date and time signals from the timing circuit such that the processor executes the programmed set of instructions to control the door open or close via the linear motor driver.

Further, the control module further comprises a wireless control circuit for reporting external wireless control signals to the processor, the programmed set of instructions are adapted for receiving the external wireless control signals from the wireless control circuit such that the processor executes the programmed set of instructions to control the door open or close via the linear motor driver.

Further, the external wireless control signals are Wi-Fi signals provided by an electrical device of a user such that the door is open or closed by the user via the electrical device.

Further, the control module further comprises a light sensor for detecting sunrise time and sunset time and reporting the sunrise time and the sunset time to the processor, such that the processor executes the programmed set of instructions to open the door at the sunrise time and close the door at the sunset time based on the sunrise time and the sunset time.

Further, the control module further comprises an infrared sensor disposed on the sliding element and configured to detect whether an animal is located at the opening, when the infrared sensor detects an animal is located at the opening, the infrared sensor reports to the processor, and the processor executes the programmed set of instructions to open the door.

The present invention further provides an animal automatic door system including: an animal door module comprising two sliding elements facing with each other and a door, the door connected with the two sliding elements in a sliding mode, the door configured to slide along the two sliding elements between a closed position covering an opening between the two sliding elements and an open position away from the opening; an linear motor driver connected with the door and configured to drive the door move between the closed position and the open position; and a control module electrically connected the linear motor driver and configured to control the linear motor driver open or close the door according to a programmed set of instructions.

The present invention also has the beneficial effects: the linear motor driver is only controlled by the control module based on the programmed set of instructions, and the door cannot be moved without the controls of the control module by the programmed set of instructions. That is, the door can't be open or closed by external force, such that when the door is closed, foraging animals, such as, for example, foxes and hyenas, cannot open the door and enter a room within which the animals are present and then kill the animals. The room of the animals can be safe by use of the automatic animal door system. In addition, the automatic animal door system is also simple in manufacture, installation and use.

### BRIEF DESCRIPTIONS OF THE DRAWINGS

Implementations of the present invention will now be described, by way of embodiment, with reference to the attached figures. It should be understood that the drawings are shown for illustrative purpose only. For ordinary persons skilled in the art, other drawings obtained from these drawings without paying creative labor by an ordinary person skilled in the art should be within scope of the present disclosure.

FIG. 1 is a structure diagram of an automatic animal door system according to an embodiment of the present invention in an open state;

FIG. 2 is a structure diagram of the automatic animal door system of FIG. 1 in a closed state;

FIG. 3 is a cross-section view of an animal door module of the automatic animal door system of FIG. 1; and

FIG. 4 is a circuit diagram of a control module of the automatic animal door system of FIG. 1.

### DETAILED DESCRIPTION OF THE ILLUSTRATED EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The invention is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the invention, “a plurality of” means two or more, unless otherwise specifically defined.

The terms “top”, “bottom”, and other indicating directions or positions are based on the directions or positions shown in the attached drawings in order to facilitate the description of the embodiment and simplify the description of the invention, rather than indicating or implying that the device or element referred to must have a specific orientation, be constructed and operated in a specific orientation, it cannot be understood as a limitation of the embodiment of the invention.

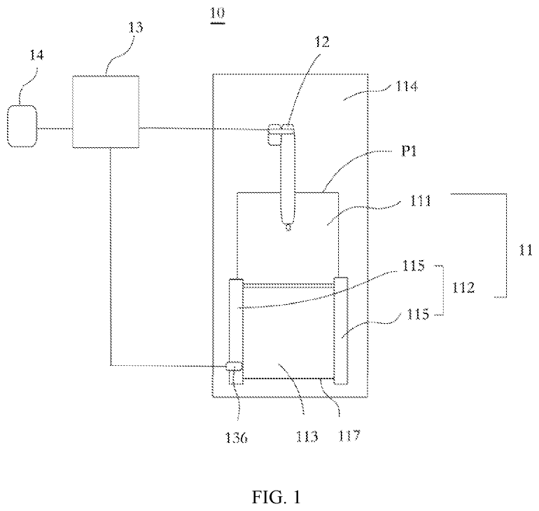

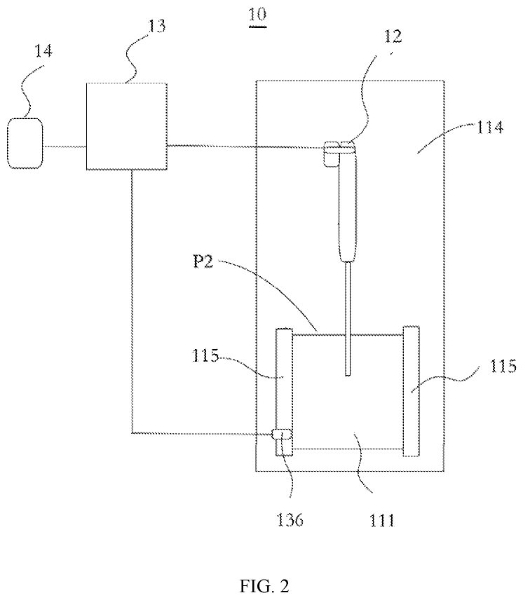

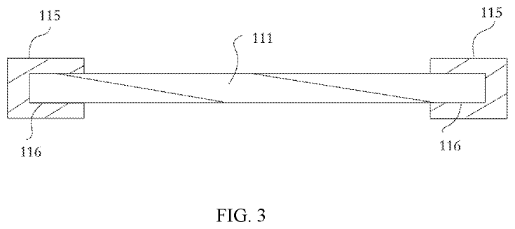

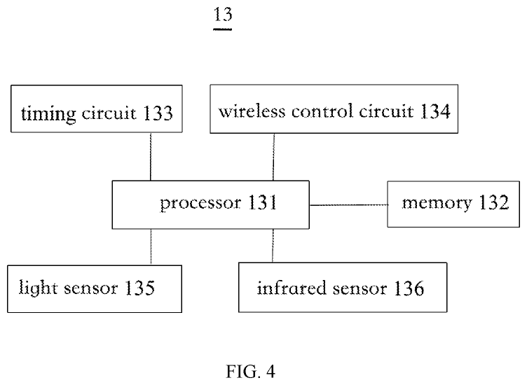

Referring to FIGS. 1-4, an embodiment of the present invention provides an automatic animal door system 10. The automatic animal door system 10 includes an animal door module 11, an linear motor driver 12, a control module 13 and a power source 14.

The animal door module 11 includes a door 111 and a frame 112 having an opening 113. The door 111 can be an aluminum alloy plate, and is lively connected with the frame 112 and configured to move between an open position P1 covering the first opening 113 and a closed position P2 away from the first opening 113. The linear motor driver 12 is connected with the door 111 and configured to drive the door 111 move between the open position P1 and the closed position P2 so as to open or close the door 111. It can be understood, the frame 112 can be installed on a wall 114 (or another door), the wall 114 may include a second opening 117 corresponding to the first opening 113. When the door 111 is located at the opening position P1, the door 111 is open, animals can pass through the first opening 113 and the second opening 117. When the door 111 is located at the closed position P2, the first opening 113 and the second opening 117 is covered by the door 111 and the door 111 is closed, animals can not pass through the first opening 113 and the second opening 117.

The frame 112 includes two sliding elements 115 facing with each other. The two sliding elements 115 are located at two opposite sides of the first opening 113. The door 111 is connected with the two sliding elements 115 in a sliding mode. Each sliding element 115 includes a chute 116. Two opposite sides of the door 111 are connected with the two chutes 116 of the two sliding elements 115 in a sliding mode and configured to slide along the two chutes 116 as as to move between the open position P1 and the closed position P2. The sliding element 115 can be made of aluminum alloy.

In the embodiment, the linear motor driver 12 can be fixed on the main body 114. In other embodiment, the linear motor driver 12 can be fixed on other wall.

The control module 13 is electrically connected the linear motor driver 12. The control module 13 is electrically connected the linear motor driver 12 and configured to control the linear motor driver 12 open or close the door according to a programmed set of instructions. In addition, the control module 13 is configured to control the linear motor driver 12 drive the door 111 slide along the two sliding elements 115 so as to move between the open position P1 and the closed position P2.

The control module 13 includes a processor 131, a non-volatile memory 132 storing the programmed set of instructions, a timing circuit 133, a wireless control circuit 134, a light sensor 135 and an infrared sensor 136. The processor 131 is electrically connected to the memory 132, the timing circuit 133, the wireless control circuit 134, the light sensor 135 and the infrared sensor 136.

The timing circuit 133 is configured for reporting date and time to the processor 131, the programmed set of instructions are adapted for receiving date and time signals from the timing circuit 133 such that the processor 131 executes the programmed set of instructions to control the door 111 open or close via the linear motor driver 12. In the embodiment, the processor 131 may execute the programmed set of instructions to open the door at sunrise time and close the door at sunset time based on the date and time signals from the timing circuit 133.

The wireless control circuit 134 is configured for reporting external wireless control signals to the processor 131, the programmed set of instructions are adapted for receiving the external wireless control signals from the wireless control circuit 134 such that the processor 131 executes the programmed set of instructions to control the door 111 open or close. The external wireless control signals can be Wi-Fi signals provided by an electrical device (such as an mobile phone) of a user such that the door 111 is open or closed by the user via the electrical device.

The light sensor 135 is configured for detecting sunrise time and sunset time and reporting the sunrise time and the sunset time to the processor 131, such that the processor 131 executes the programmed set of instructions to open the door 111 at the sunrise time and close the door at the sunset time based upon the sunrise time and the sunset time.

The infrared sensor 136 can be an infrared diffuse reflection photoelectric switch, and the infrared sensor 136 is disposed on the frame and configured to detect whether an animal is located at the first opening 113. When the infrared sensor 136 detects an animal is located at the first opening 113, the infrared sensor 136 reports to the processor, 131 and the processor 131 executes the programmed set of instructions to open the door 111.

The power source 14 is electrically connected the control module 13 and the linear motor driver 12 respectively to supply the control module 13 and the linear motor driver 12. In the embodiment, the power sourcel4 can be a wall outlet for receiving power from a utility line. In other embodiment, the power source 14 may includes at least one battery, or at least one rechargeable battery in conjunction with at least one solar cell that is adapted to recharge the at least one rechargeable battery.

In the embodiment, the linear motor driver 12 is only controlled by the control module 13 based on the programmed set of instructions, and the door 111 cannot be moved without the controls of the control module 13 by the programmed set of instructions. That is, the door 111 can't be open or closed by external force, such that when the door 111 is closed, foraging animals (such as foxes and hyenas) can not open the door 111 and enter an room of the animals to kill the animals. The room of the animals can be safe by use of the automatic animal door system 10. In addition, the automatic animal door system 10 is also simple in manufacture, installation and use.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

1. An automatic animal door system, comprising:
an animal door module comprising a door and a frame having an opening, the door movably connected with the frame and configured to move between a closed position covering the opening and an open position away from the opening, wherein the frame comprises two sliding elements facing with each other, the two sliding elements are located at two sides of the opening, each sliding element is u-shaped to define a chute, two opposite sides of the door slidably arranged in the two chutes and are configured to slide along the two chutes the door;
a linear motor driver connected with the door and configured to drive the door move between the closed position and the open position; and
a control module electrically connected the linear motor driver, comprising a processor and a non-volatile memory storing a programmed set of instructions, and the processor configured to execute the programmed set of instructions to control the linear motor driver open or close the door, wherein the control module is configured to control the linear motor driver drive the door slide along the two chutes so as to move between the closed position and the open position.

2. (canceled)

3. (canceled)

4. The automatic animal door system according to claim 1, wherein the linear motor driver is fixed on a wall.

5. The automatic animal door system according to claim 1, wherein the automatic animal door system further comprises a power source, the power source is electrically connected the control module and the linear motor driver respectively to supply the control module and the linear motor driver.

6. The automatic animal door system according to claim 5, wherein the power source is a wall outlet for receiving power from a utility line.

7. The automatic animal door system according to claim 5, wherein the power source comprises at least one battery, or at least one rechargeable battery in conjunction with at least one solar cell that is adapted to recharge the at least one rechargeable battery.

8. The automatic animal door system according to claim 1, wherein the control module further comprises a timing circuit for reporting date and time to the processor, the programmed set of instructions are adapted for receiving date and time signals from the timing circuit such that the processor executes the programmed set of instructions to control the door open or close via the linear motor driver.

9. The automatic animal door system according to claim 8, wherein the processor executes the programmed set of instructions to open the door at sunrise time and close the door at sunset time based on the date and time signals from the timing circuit.

10. The automatic animal door system according to claim 1, wherein the control module further comprises a wireless control circuit for reporting external wireless control signals to the processor, the programmed set of instructions are adapted for receiving the external wireless control signals from the wireless control circuit such that the processor executes the programmed set of instructions to control the door open or close via the linear motor driver.

11. The automatic animal door system according to claim 10, wherein the external wireless control signals are Wi-Fi signals provided by an electrical device of a user such that the door is open or closed by the user via the electrical device.

12. The automatic animal door system according to claim 1, wherein the control module further comprises a light sensor for detecting sunrise time and sunset time and reporting the sunrise time and the sunset time to the processor, such that the processor executes the programmed set of instructions to open the door at the sunrise time and close the door at the sunset time based on the sunrise time and the sunset time.

13. The automatic animal door system according to claim 1, wherein the control module further comprises an infrared sensor disposed on the frame and configured to detect whether an animal is located at the opening, when the infrared sensor detects an animal is located at the opening, the infrared sensor reports to the processor, and the processor executes the programmed set of instructions to open the door.

14. An automatic animal door system, comprising:
an animal door module comprising two sliding elements facing with each other and a door, the door connected with the two sliding elements in a sliding mode, the door configured to slide along the two sliding elements between a closed position covering an opening between the two sliding elements and an open position away from the opening, wherein the two sliding elements are located at two sides of the opening, each sliding element is u-shaped to define a chute, two opposite sides of the door slidably arranged in the two chutes and are configured to slide along the two chutes the door;
a linear motor driver connected with the door and configured to drive the door slide between the closed position and the open position; and
a control module electrically connected the linear motor driver, comprising a processor and a non-volatile memory storing a programmed set of instructions, and the processor configured to execute the programmed set of instructions to control the linear motor driver open or close the door, wherein the control module is configured to control the linear motor driver drive the door slide along the two chutes so as to move between the closed position and the open position.

15. The automatic animal door system according to claim 14, wherein the control module further comprises a timing circuit for reporting date and time to the processor, the programmed set of instructions are adapted for receiving date and time signals from the timing circuit such that the processor executes the programmed set of instructions to control the door open or close via the linear motor driver.

16. The automatic animal door system according to claim 14, wherein the control module further comprises a wireless control circuit for reporting external wireless control signals to the processor, the programmed set of instructions are adapted for receiving the external wireless control signals from the wireless control circuit such that the processor executes the programmed set of instructions to control the door open or close via the linear motor driver.

17. The automatic animal door system according to claim 16, wherein the external wireless control signals are Wi-Fi signals provided by an electrical device of a user such that the door is open or closed by the user via the electrical device.

18. The automatic animal door system according to claim 14, wherein the control module further comprises a light sensor for detecting sunrise time and sunset time and reporting the sunrise time and the sunset time to the processor, such that the processor executes the programmed set of instructions to open the door at the sunrise time and close the door at the sunset time based on the the sunrise time and the sunset time.

19. The automatic animal door system according to claim 14, wherein the control module further comprises an infrared sensor disposed on the sliding element and configured to detect whether an animal is located at the opening, when the infrared sensor detects an animal is located at the opening, the infrared sensor reports to the processor, and the processor executes the programmed set of instructions to open the door.

20. An automatic animal door system, comprising:
an animal door module comprising two sliding elements facing with each other and a door, the door connected with the two sliding elements in a sliding mode, the door configured to slide along the two sliding elements between a closed position covering an opening between the two sliding elements and an open position away from the opening, wherein the two sliding elements are located at two sides of the opening, each sliding element is u-shaped to define a chute, two opposite sides of the door slidably arranged in the two chutes and are configured to slide along the two chutes the door;
a linear motor driver connected with the door and configured to drive the door move between the closed position and the open position; and
a control module electrically connected the linear motor driver and configured to control the linear motor driver open or close the door according to a programmed set of instructions, wherein the control module is configured to control the linear motor driver drive the door slide along the two chutes so as to move between the closed position and the open position.
